(19) United States
(12) Patent Application Publication
(10) Pub. No.: US 2026/0284775 A1
(43) Pub. Date: Sep. 24, 2026

(54) TOOLING FOR ADDITIVE FRICTION STIR DEPOSITION

(71) Applicant: University of Kentucky Research Foundation, Lexington, KY (US)

(72) Inventors: James Robert Caudill, Lexington, KY (US); Sarvesha Rajashekara, Lexington, KY (US); Ibrahim S. Jawahir, Lexington, KY (US); Nimesh Fernando, Lexington, KY (US)

(21) Appl. No.: 19/570,549

(22) Filed: Mar. 18, 2026

Related U.S. Application Data
(60) Provisional application No. 63/773,981, filed on Mar. 18, 2025.

(51) Int. Cl. B23K 20/12; B33Y 30/00

(52) U.S. Cl. CPC B23K 20/1215; B23K 20/1255; B33Y 30/00

(57) ABSTRACT

A tool, adapted for additive friction stir deposition, has a tool body having a face including a feedstock feed opening and a first protrusion adapted to smear and shear deposited feedstock material to ensure good print quality. The first protrusion extends in a spiral shape at least partially around the feedstock feed opening. In an alternative embodiment, the tool has a face including a feedstock feed opening and a protrusion adapted to smear and shear deposited feedstock material to ensure good print quality wherein the protrusion comprises (a) a first set of convexities arrayed around the feedstock feed opening a first radial distance from the feedstock feed opening and (b) a second set of convexities arrayed around the feedstock feed opening a second radial distance from the feedstock feed opening. The first radial distance and the second radial distance differ.

### RELATED APPLICATIONS

This application claims the benefit of U.S. Provisional Patent Application Ser. No. 63/773,981, filed Mar. 18, 2025, the disclosure of which is incorporated herein by reference.

### STATEMENT REGARDING FEDERALLY SPONSORED RESEARCH OR DEVELOPMENT

This invention was made with government support under contract number W911NF-21-2-0075 awarded by the Army Research Office. The government has certain rights in the invention.

### BACKGROUND

Additive friction stir deposition (AFSD) is a recently emerging and advanced 3D printing technology that fabricates metal or composite structures without melting the material. Unlike conventional fusion-based additive manufacturing (AM) techniques such as laser powder bed fusion (LPBF), directed energy deposition (DED), or electron beam melting (EBM), AFSD processes utilize plastic deformation-driven consolidation mechanisms to create parts at lower temperatures.

This approach prevents the formation of defects related to high-temperature phase transformations, residual stresses, and metallurgical porosity. AFSD is especially beneficial for manufacturing parts with superior mechanical properties, refined microstructures, and minimal distortion. As such it is being targeted heavily by the Department of Defense (DoD) and it's industrial base as a means to address shortcomings in the current supply chain (particularly for large-scale components).

This process works via the friction generated from a rotating tool and material intermixing is promoted through stirring protrusions on the face of the tool. This document discloses custom tool geometries that promote better material properties, including enhanced isotropic behavior.

### SUMMARY

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, "substantially" is meant to permit deviations from the descriptive term that don't negatively impact the intended purpose. Descriptive terms are implicitly understood to be modified by the word substantially, even if the term is not explicitly modified by the word substantially.

As used herein, the singular forms “a,” “an” and “the” include plural referents unless the context clearly dictates otherwise.

As used herein, “about,” “approximate,” “at or about,” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

In accordance with the purposes and benefits set forth herein, a new and improved tool, adapted for additive friction stir deposition, comprises, consists of or consists essentially of a tool body having a face including a feedstock feed opening and a first protrusion adapted to smear and shear deposited feedstock material to ensure good print quality wherein the first protrusion extends in a spiral shape at least partially around the feedstock feed opening.

The first protrusion may have a first end, a second end and a length of between 46 mm and 37 mm. The first protrusion may have a radius of curvature of between 7 mm and 19 mm. The radius of curvature may decrease from the first end to the second end. The first protrusion may have a height of between about 1.75 and about 2.25 mm.

In at least some embodiments, the tool body may further include a second protrusion. The second protrusion may also be adapted to smear and shear deposited feedstock material to ensure good print quality. The second protrusion may also extend in a spiral shape at least partially around the feedstock feed opening. In at least some embodiments, the second protrusion opposes the first protrusion.

The second protrusion may have a first end, a second end and a length of between 46 and 37 mm. The second protrusion may have a radius of curvature of between 7 and 19 mm. The radius of curvature may decrease from the first end to the second end. The second protrusion may have a height of between about 1.75 and about 2.25.

In at least some of the many possible embodiments, (a) the first end of the first protrusion is substantially axially aligned with the second end of the second protrusion and (b) the second end of the first protrusion is substantially axially aligned with the first end of the second protrusion. In some embodiments, the first and second ends of the first protrusion and the second protrusion all fall on a diametric line of the tool. In some embodiments, the feedstock feed opening is adapted to hold one or more feedstock rods.

In accordance with yet another aspect, a tool adapted for additive friction stir deposition, comprises, consists of or consists essentially of a tool body having a face including a feedstock feed opening and a protrusion. The protrusion is adapted to smear and shear deposited feedstock material to ensure good print quality. The protrusion comprises (a) a first set of convexities arrayed around the feedstock feed opening a first radial distance from the feedstock feed opening and (b) a second set of convexities arrayed around the feedstock feed opening a second radial distance from the feedstock feed opening wherein the first radial distance and the second radial distance differ.

In at least one possible embodiment, the first set of convexities are angularly offset from the second set of convexities.

In at least some embodiments, the protrusion also includes a third set of convexities arrayed around the feedstock feed opening a third radial distance from the feedstock feed opening wherein the third radial distance differs from the first radial distance and the second radial distance.

In some embodiments, the first, second and third set of convexities are angularly aligned.

Other systems, methods, features, and advantages of the present disclosure will be or become apparent to one with skill in the art upon examination of the following drawing and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWING FIGURES

Many aspects of the present disclosure can be better understood with reference to the following drawing figure. The components in the drawing figure are not necessarily to scale, emphasis instead being placed upon clearly illustrating the principles of the present disclosure.

FIG. 1 is a perspective view of an additive friction stir deposition system.

FIG. 2 is a side elevational schematic view of an additive stir deposition system.

FIG. 3 is a detailed perspective view of an additive stir deposition system tool incorporating a vortex tool face.

FIG. 4 is a first possible embodiment of a new and improved tool incorporating vortex shaped protrusions adapted to smear and shear deposited feedstock material to ensure good print quality.

FIG. 5 is a second possible embodiment of a new and improved tool incorporating two sets of radially arrayed and angularly offset protrusions or convexities adapted to smear and shear deposited feedstock material to ensure good print quality.

FIG. 6 is a third possible embodiment of a new and improved tool incorporating three sets of radially arrayed and aligned protrusions or convexities adapted to smear and shear deposited feedstock material to ensure good print quality.

FIGS. 7A-7D illustrate a family of tools all incorporating vortex-shaped protrusions. The FIG. 7A embodiment incorporates a single, relatively small, square-shaped feed rod opening. The FIG. 7B embodiment incorporates a single, medium-sized, square-shaped feed rod opening. The FIG. 7C embodiment incorporates a single, relatively large, square-shaped feed rod opening. The FIG. 7D embodiment incorporates two relatively small, circular feed rod openings.

FIGS. 8A-8C are coupled thermos-mechanical simulations spatial distributions illustrating the enhanced mixing efficiency and more uniform reinforcement dispersion possible with a vortex-shaped protrusion (FIG. 8C) as compared to a state of the art flat tool (FIG. 8A) and a state of the art four protrusion tool (FIG. 8B).

### DETAILED DESCRIPTION

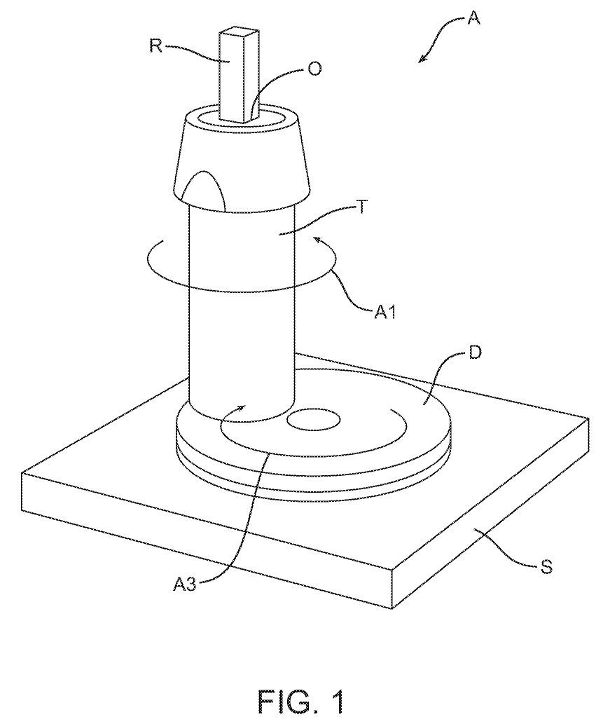

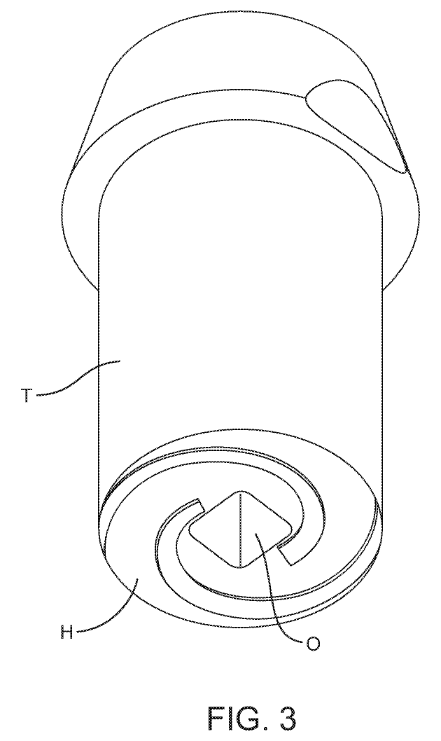

Reference is now made to FIGS. 1-3 which generally illustrate a device or system A for performing additive friction stir deposition. Additive friction stir deposition fabricates metal or composite structures without melting the material. The resulting solid-phase fabrication has a number of benefits, compared with traditional additive manufacturing based on melting–solidification cycles. Not only is additive friction stir deposition more efficient, it also solves the problems of porosity, cracks, and residual stress caused by the melting– solidification process.

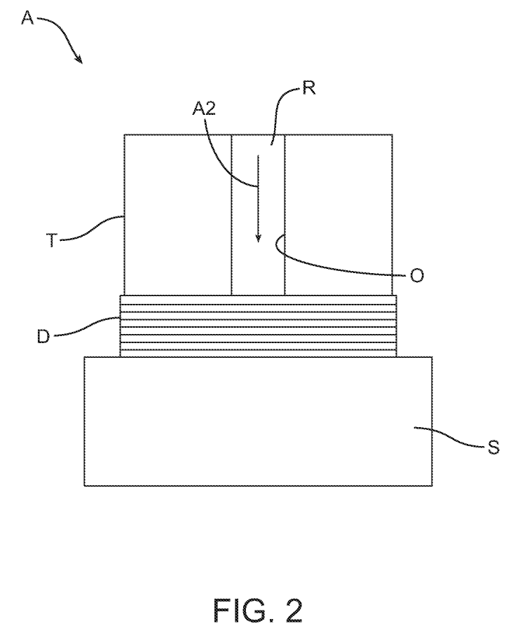

As shown, an additive friction stir deposition tool T is rotated in a counter-clockwise direction (note Action Arrow A1 in FIG. 1) as a rod R of feedstock material is feed through a central feed opening O in the tool (note Action Arrow A2 in FIG. 2). In the illustrated embodiment, the tool T includes a tool face or print head H. Downward pressure on the feedstock rod R and tool T in conjunction with high speed tool rotation produces severe plastic deformation at high temperatures below the melting point of the feedstock material. When the substrate S is rotated in a clockwise direction as shown (note Action Arrow A3 in FIG. 1), the feedstock material is deposited layer-by-layer D eventually resulting in a printed component of fine, recrystallized grains. Such a component generally exhibits properties similar to a forged part.

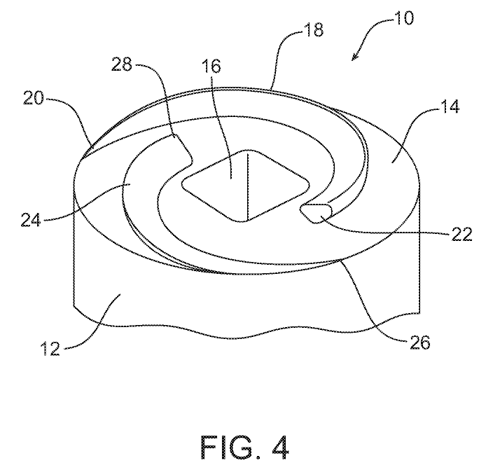

Reference is now made to FIG. 4 illustrating a first possible embodiment for a tool 10 adapted for additive friction stir deposition. As noted above, in additive friction stir deposition, a high-speed rotating stirring tool head H prints or deposits a feedstock material at temperatures below the material melting point. Dynamic friction from the interaction of the print head H, material to be deposited, and the previously deposited material (or workpiece) causes the material to heat, soften, plastically deform, and bond.

The tool 10 includes a tool body 12 made from any appropriate material including, but not necessarily limited to, titanium alloy Ti-6Al-4V, providing high fatigue strength, low acoustic loss and thermal stability capable of withstanding the heat generated during the additive friction stir deposition process. In some embodiments a ceramic tip may be used on the tool.

As shown in FIG. 4, the tool body 12 (or ceramic tip if present) includes a face 14 having a feedstock feed opening 16 adapted for feeding a feedstock material (not shown) to be deposited on a workpiece. The feedstock material may in the form of a rod or powder. The feedstock material may comprise any metal, composite or ceramic material suitable for additive friction stir deposition, such as aluminum, copper, steel, titanium, magnesium, nickel, zinc and lead such as aluminum and aluminum based alloys, copper and copper based alloys, steel and steel based alloys, titanium and titanium based alloys, magnesium and magnesium based alloys, nickel and nickel based alloys, and high entropy alloys.

The face 14 of the tool body 12 also includes a first protrusion 18 adapted to smear and shear deposited feedstock material to ensure good print quality. The first protrusion 18 extends in a spiral shape at least partially around the feedstock feed opening 16. The first protrusion 18 may have a first end 20, a second end 22 and a length between the ends of between 46 mm and 37 mm.

The first protrusion 18 may have a radius of curvature of between 7 mm and 19 mm. In one possible embodiment illustrated in FIG. 4, the radius of curvature decreases from the first end 20 to a second end 22. The first protrusion 18 may have a height (i.e. distance projecting above the face 14) of between about 1.75 and about 2.25 mm.

As illustrated in FIG. 4, the tool body 12 further includes a second protrusion 24 also adapted to smear and shear deposited feedstock material to ensure good print quality. Like the first protrusion 18, the second protrusion 24 extends in a spiral shape at least partially around the feedstock feed opening. In the illustrated embodiment, the second protrusion 24 opposes the first protrusion 18.

The second protrusion has a first end 26, a second end 28 and a length of between 46 and 37 mm. The second protrusion has a radius of curvature of between 7 and 19. The radius of curvature preferably decreases from the first end 26 to the second end 28. The second protrusion 24 has a height of between about 1.75 and about 2.25 mm, matching the first protrusion. The height of the protrusions 18, 24 helps control the thickness of the layer of feedstock material being applied to the workpiece.

As further illustrated in the embodiment shown in FIG. 4, the first end 20 of the first protrusion 18 is substantially axially aligned with the second end 28 of the second protrusion 24. Similarly, the second end 22 of the first protrusion 18 is substantially axially aligned with the first end 26 of the second protrusion 24. Further, the first and second ends 20, 22, 26, 28 of the first protrusion 18 and the second protrusion 24 may all fall on a diametric line of the tool 10.

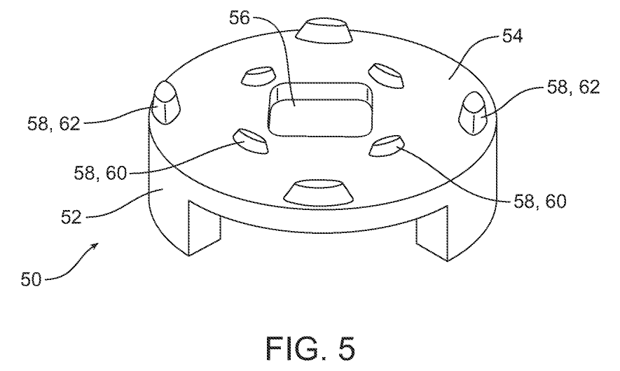

FIG. 5 illustrates a second possible embodiment of a tool 50 including a tool body 52 having a face 54 including a feedstock feed opening 56 and a protrusion, generally designated by reference numeral 58. The protrusion 58 is adapted to smear and shear deposited feedstock material to ensure good print quality. In FIG. 5, the protrusion 58 comprises (a) a first set of convexities 60 arrayed around the feedstock feed opening 56 a first radial distance from the feedstock feed opening and (b) a second set of convexities 62 arrayed around the feedstock feed opening a second radial distance from the feedstock feed opening wherein the first radial distance and the second radial distance differ. As illustrated, the first radial distance is less than the second radial distance.

In the embodiment illustrated in FIG. 5, the first set of convexities 60 are angularly offset from the second set of convexities 62. For example, the first set of convexities 60 may be provided with one convexity at 90 degrees, one convexity at 180 degrees, one convexity at 270 degrees and one convexity at 360 degrees. In contrast, the second set of convexities 62 may be provided with one convexity at 45 degrees, one convexity at 135 degrees, one convexity at 225 degrees and one convexity at 315 degrees.

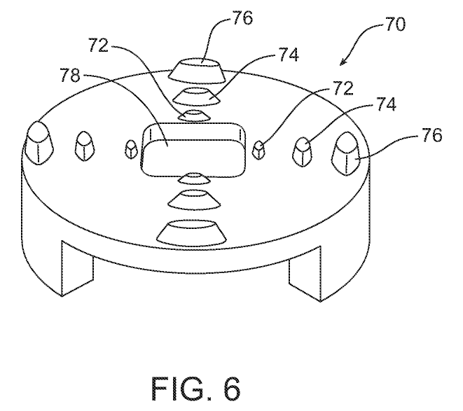

In a third possible embodiment of a tool 70 illustrated in FIG. 6, the tool includes a first set of convexities 72, a second set of convexities 74 and a third set of convexities 76 arrayed around the feedstock feed opening 78. More specifically, the first set of convexities 72 are radially arrayed at a first radial distance, the second set of convexities 74 are radially arrayed at a second radial distance and the third set of convexities 76 are radially arrayed at a third radial distance wherein the first radial distance is less than the second radial distance which is less than the third radial distance. As further illustrated in FIG. 6, the first, second and third set of convexities 72, 74, 76 are angularly aligned at 90 degrees, 180 degrees, 270 degrees and 360 degrees. Of course other arrangements including offset convexities 72, 74 and 76 may also be provided. The size and/or shape of the convexities 72, 74, 76 may vary within or between sets.

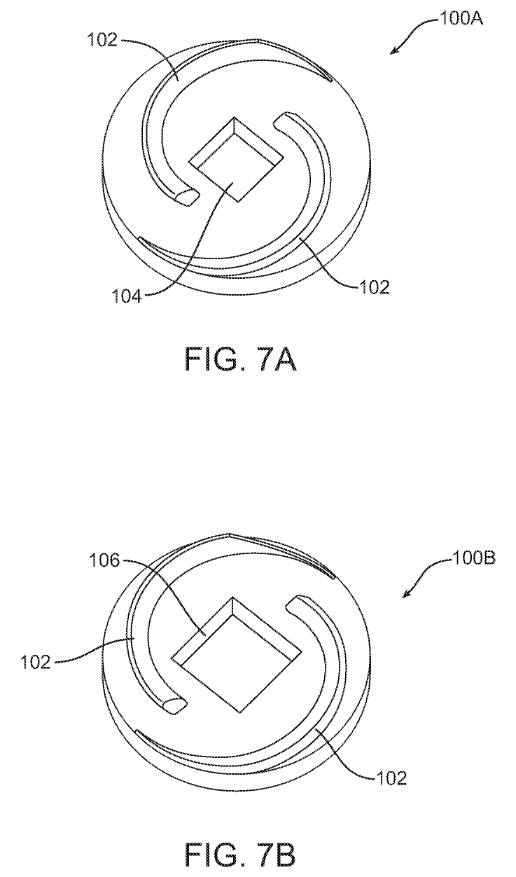

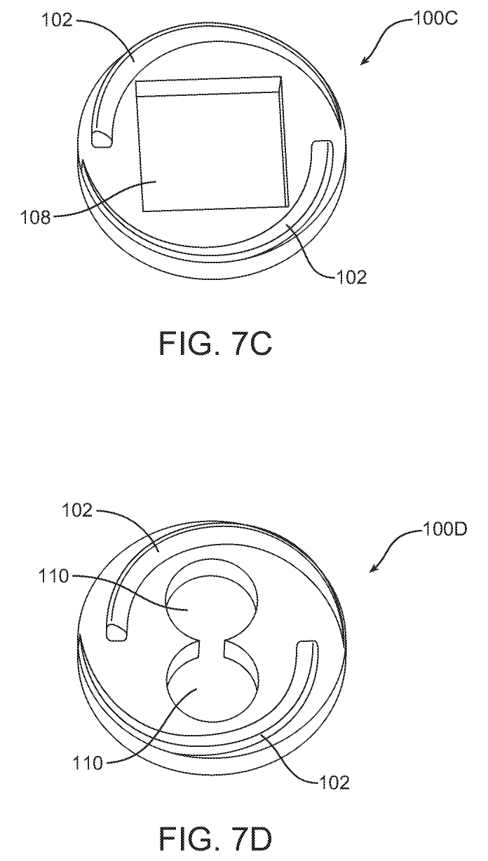

Reference is now made to FIGS. 7A-7D illustrating a family of tools 100A-100D each including vortex-shaped protrusions 102 of the type shown in FIG. 4 and described above. In FIG. 7A, the pair of spiral-shaped protrusions 102 extend at least partially around a single, relatively small, square-shaped feedstock feed opening 104 (e.g. each side of the opening having a length of about 9.56 mm). In FIG. 7B, the pair of spiral-shaped protrusions 102 extend at least partially around a single, relatively medium-sized, square-shaped feedstock feed opening 106 (e.g. each side of the opening having a length of about 12.7 mm).

In FIG. 7C, the pair of spiral-shaped protrusions 102 extend at least partially around a single, relatively large, square-shaped feedstock feed opening 108 (e.g. each side of the opening having a length of about 19.05 mm). Finally, in FIG. 7D, the pair of spiral-shaped protrusions 102 extend at least partially around two round feedstock feed openings 110 (e.g. each opening having a diameter of about 12.7 mm). It should be appreciated that the tool embodiments illustrated in FIGS. 7A-7D are illustrative in nature and not restrictive. The tools 100A-100D could include any number of spiral shaped protrusions (e.g. 1, 2, 3, 4, n) and any number and shape of feedstock feed openings. As illustrated in FIG. 1, 3 and 4, the tool print head protrusions are integrated directly into the monolithic, full length tool body. In alternative embodiments illustrated in FIGS. 5 and 6, the tool heads are formed as detachable tool face inserts that may be secured in a tool holder by fasteners of a type known in the art.

The arrangement and geometry of the protrusions 18, 24, 58, 72, 74, 76, 102 shown in the various embodiments illustrated in FIGS. 4-6 and 7A-7D fundamentally alter material flow during the additive friction stir deposition process. Unlike flat or discrete protrusion tool designs, the spiral configuration of FIGS. 4 and 7A-7D generates a sustained, radially distributed vortex flow field beneath the tool. This geometry simultaneously controls mechanical loading, heat generation, and strain distribution in a coupled manner. The spiral configuration of protrusions:
(a) provides a more lateral force profile;
(b) exhibits the lowest forging force due to improved load distribution and reduced flow resistance;
(c) provides the highest peak temperatures with the most uniform thermal distribution, resulting from minimized convective heat loss; and
(d) provides a broader, more uniform strain field across the tool–material interface.

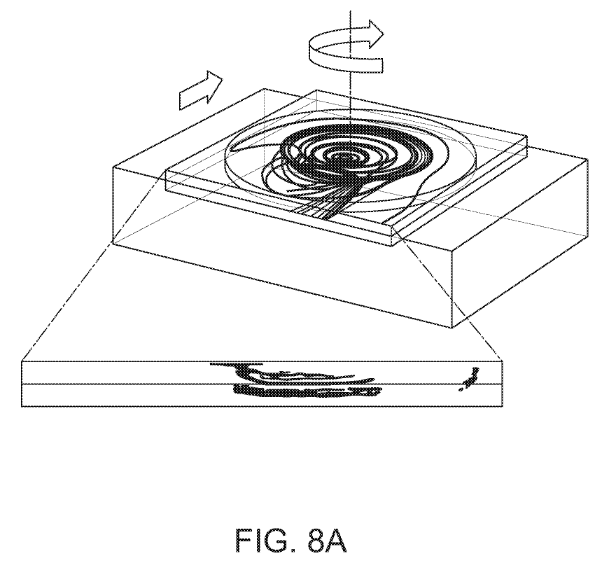

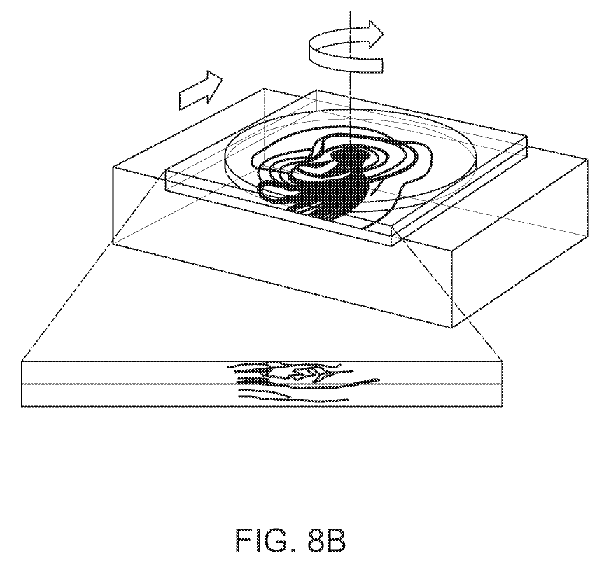

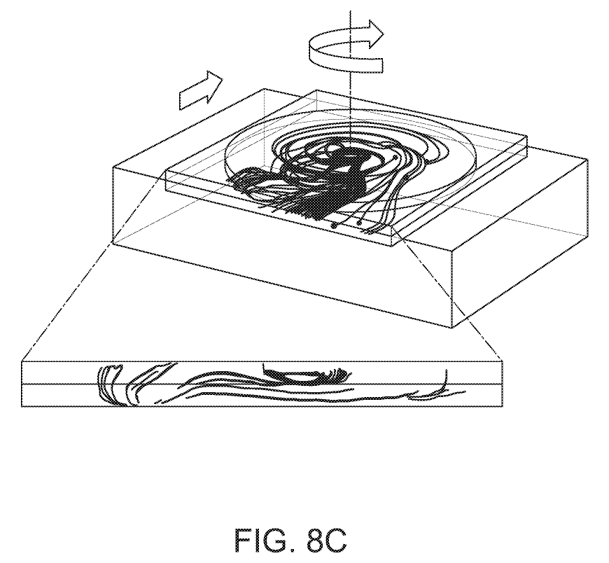

The vortex geometry of the tool print head illustrated in FIGS. 4 and 7A-7D produces significant process and material advantages including, but not necessarily limited to:
(a) more uniform and radially distributed dynamic recrystallization;
(b) broader distribution of fine equiaxed grains across the deposit;
(c) enhanced refinement of Mg–Si second-phase particles (smaller particle size and reduced inter-particle spacing);
(d) higher strain rates and velocities, promoting microstructural refinement;
(e) improved material dispersion in metal matrix composite fabrication (Refer to FIGS. 8A-8C where the material is dispersed by the vortex tool over a significantly greater area (see FIG. 8C) as compared to material dispersion for the flat tool (see FIG. 8A) and the state-of-the-art four protrusion tool (see FIG. 8B)); and
(f) superior as-deposited mechanical properties, including the highest strength along the build direction.

Collectively, the new and improved tool heads 10, 50, 70, 100A, 100B, 100C, and 100D with the protrusions improve process stability, microstructural uniformity, reinforcement dispersion, and mechanical performance in additive friction stir deposition deposits while reducing mechanical resistance during deposition.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

What is claimed:

1. A tool adapted for additive friction stir deposition, comprising:
a tool body having a face including a feedstock feed opening and a first protrusion adapted to smear and shear deposited feedstock material to ensure good print quality wherein the first protrusion extends in a spiral shape at least partially around the feedstock feed opening.

2. The tool of claim 1, wherein the first protrusion has a first end, a second end and a length of between 46 mm and 37 mm.

3. The tool of claim 1, wherein the first protrusion has a radius of curvature of between 7 mm and 19 mm.

4. The tool of claim 3, wherein the radius of curvature decreases from a first end to a second end.

5. The of claim 1, wherein the first protrusion has a height of between 1.75 and 2.25 mm.

6. The tool of claim 1, wherein the tool body further includes a second protrusion adapted to smear and shear deposited feedstock material to ensure good print quality wherein the second protrusion extends in a spiral shape at least partially around the feedstock feed opening.

7. The tool of claim 6, wherein the second protrusion opposes the first protrusion.

8. The tool of claim 6, wherein the second protrusion has a first end, a second end and a length of between 46 and 37 mm.

9. The tool of claim 6, wherein the second protrusion has a radius of curvature of between 7 and 19 mm.

10. The tool of claim 9, wherein the radius of curvature decreases from a first end to a second end.

11. The tool of claim 6, wherein the second protrusion has a height of between 1.75 and 2.25 mm.

12. The tool of claim 8 wherein (a) the first end of the first protrusion is substantially axially aligned with the second end of the second protrusion and (b) the second end of the first protrusion is substantially axially aligned with the first end of the second protrusion.

13. The tool of claim 12, wherein the first and second ends of the first protrusion and the second protrusion all fall on a diametric line of the tool.

14. The tool of claim 1, wherein the food stock feed opening is adapted to hold one or more feedstock rods.

15. A tool adapted for additive friction stir deposition, comprising:
a tool body having a face including a feedstock feed opening and a protrusion adapted to smear and shear deposited feedstock material to ensure good print quality wherein the protrusion comprises (a) a first set of convexities arrayed around the feedstock feed opening a first radial distance from the feedstock feed opening and (b) a second set of convexities arrayed around the feedstock feed opening a second radial distance from the feedstock feed opening wherein the first radial distance and the second radial distance differ.

16. The tool of claim 15, wherein the first set of convexities are angularly offset from the second set of convexities.

17. The tool of claim 15, further including a third set of convexities arrayed around the feedstock feed opening a third radial distance from the feedstock feed opening wherein the third radial distance differs from the first radial distance the second radial distance.

18. The tool of claim 17 wherein the first, second and third set of convexities are angularly aligned.
